(19) United States
(12) Patent Application Publication
(10) Pub. No.: US 2012/0000561 A1
(43) Pub. Date: Jan. 5, 2012

(54) Pressure Accumulator Device for Connecting to a Hydraulic System

(75) Inventors: Peter Schuttermair, Gessertshausen (DE); Matthias Mueller, Langenau (DE)

(73) Assignee: Robert Bosch GmbH, Stuttgart (DE)

(21) Appl. No.: 13/172,194

(22) Filed: Jun. 29, 2011

(30) Foreign Application Priority Data
Jul. 5, 2010 (DE) 10 2010 026 092.4

(51) Int. Cl. F16L 55/04

(52) U.S. Cl. 138/30

(57) ABSTRACT

A pressure accumulator device for connecting to a hydraulic system is disclosed. The pressure accumulator device has at least one accumulator element for storing pressure energy and has an accumulator line for connecting the accumulator element to the hydraulic system. The pressure accumulator device also has a sealed encapsulation of the accumulator element and/or of the accumulator line to form a closed volume, and a device, which interacts with the accumulator element, for reducing the hydraulic pressure in the accumulator element.

This application claims priority under 35 U.S.C. §119 to German patent application no. DE 10 2010 026 092.4, filed Jul. 5, 2010 in Germany, the disclosure of which is incorporated herein by reference in its entirety.

### BACKGROUND

The disclosure relates to a pressure accumulator device for connecting to a hydraulic system, the pressure accumulator device having at least one accumulator element for storing pressure energy and an accumulator line for connecting the accumulator element to the hydraulic system.

Pressure accumulators are provided for example for buffering, and thereby making accessible for later use, energy accrued during the recovery of kinetic energy. DE 10 2006 042 390 A1 discloses for example a hydraulic system by means of which kinetic energy of a vehicle can be converted into pressure energy. To store the hydrostatic energy, such a system uses a pressure accumulator which is connected to the hydraulic system via an accumulator line. A problem of such systems is that, under some circumstances, the pressure energy must be stored in the accumulator element for a relatively long period of time. To be able to store sufficient amounts of energy, high pressures are generally present in the accumulators. Said high pressures are above all also maintained when the system is shut down, such that they are available again after start-up. Leak-tightness of such a system is therefore of particular importance. This is because, even in the shut-down state, a considerable amount of pressure medium could escape in the case of even a small leak on account of the high pressure. This must be reliably prevented not only from an environmental aspect. To protect the environment, it is known for leaks to be intercepted by means of an oil pan, for example.

A disadvantage of the known systems is that leakage from the pressure accumulator is generally not detected, and therefore leakage from the pressure accumulator device is not actively prevented. It is therefore the object of the present disclosure to provide a pressure accumulator device in which leakage is reliably detected and which prevents a further escape of pressure medium.

### SUMMARY

The object is achieved by way of the pressure accumulator device according to the disclosure.

In the pressure accumulator device according to disclosure, the pressure accumulator device has an accumulator element and an accumulator line for connecting the accumulator element to the hydraulic system. The accumulator element and/or the accumulator line are surrounded by an encapsulation. The encapsulation forms a closed volume surrounding the accumulator element and/or the accumulator line. Furthermore, a device is provided which is connected to the accumulator element such that, in the event of a leak, the accumulator element is relieved of pressure and thus the hydraulic pressure is reduced. As a result of the release of pressure from the accumulator element, the pressure falls, and the further leakage of pressure medium out of the accumulator element or out of the entire accumulator device is prevented. With the features of the disclosure, an escape of pressure medium into the encapsulation surrounding the accumulator element and/or the accumulator line is detected by the encapsulation. The closed volume formed by the encapsulation leads to a pressure increase upon the ingress of leakage fluid into the volume, which pressure increase can be detected by a pressure sensing device. In reaction to a detected pressure increase, the device can then be actuated which reduces the hydraulic pressure.

Advantageous refinements of the pressure accumulator device according to the disclosure are specified in the subclaims.

It is advantageous in particular for the accumulator element to be a hydropneumatic bladder accumulator, wherein the gas pressure thereof can be reduced by means of the device for reducing the hydraulic pressure. In such a situation, a pneumatic valve may be provided for reducing the gas pressure in the pressure accumulator device and therefore the hydraulic pressure. An intervention into the hydraulic components is therefore not necessary. Since bladder accumulators are generally filled with nitrogen, such an arrangement is particularly harmless with regard to environmental damage.

It is also advantageous for the device to comprise a valve device for reducing the hydraulic pressure, having an actuator, wherein the actuator can be activated in reaction to a pressure increase in the closed volume of the encapsulation. On account of leakage into the encapsulation, a pressure increase occurs within the encapsulation. The sealed casing of the encapsulation makes it possible to detect said pressure increase and to use said pressure increase for the actuation of the actuator in reaction to the pressure increase. Here, it is possible in particular and in a particularly simple manner for a measuring surface of the actuator to be acted on by a force dependent on the pressure within the encapsulation, and to thereby form the pressure sensing means. In the simplest case, for this purpose, a connecting line is produced between the actuator of the device for reducing the hydraulic pressure and the closed volume of the encapsulation.

Alternatively, the relief device may be activated electrically. The actuator is then for example an electromagnet which activates a pneumatic valve. The pressure increase within the encapsulation is detected by means of a sensor arrangement as a pressure sensing means, for example a pressure sensor. Said pressure sensor is connected to the control unit, which in turn outputs a signal for activating the actuator.

It is particularly advantageous if, in the event of a leakage, that is to say a pressure increase within the encapsulation, being detected, the hydraulic system connected to the pressure accumulator device is additionally fully or partially shut down by the controller. In this way, it is possible to prevent a situation in which, in the case of the device for energy recovery mentioned by way of example, pressure medium continues to be fed into the then relaxed bladder accumulator. For this purpose, the control unit has a control section designed so as to output a further control signal suitable for shutting down the connected hydraulic system.

In a particularly simple embodiment, for the activation of the actuator, a pressure switch is provided as a pressure sensing means in the encapsulation. In the case of such a pressure switch, an electrical signal is generated directly as a result of the increase in pressure within the encapsulation, by means of which electrical signal an electromagnet as an actuator of the device for reducing the hydraulic pressure can be activated. Complex electronic components can therefore be dispensed with.

To reliably detect a pressure increase within the closed volume even in the case of relatively small leakage amounts, it is advantageous for a swelling agent to be provided in the encapsulation. If leakage fluid emerges from the accumulator element or the accumulator line and comes into contact with the swelling agent in the closed volume, the reaction of the swelling agent leads to an intensification of the pressure increase. At this juncture, it is pointed out once again that the primary function of the encapsulation is not for example the interception of escaping pressure medium but rather the formation of a closed volume around the accumulator element and/or the accumulator line. This is because a volume closed off in this way, together with the pressure sensing device, permits the detection of the leakage.

In order to prevent, for its part, an intense pressure increase within the encapsulation in the case of relatively large leakage quantities, it is advantageous for the encapsulation to be connected to a relief device. By means of such a relief device, the pressure within the encapsulation can be limited to a maximum value. Said maximum value is slightly higher than the pressure required for detecting the leakage. When using a relief device of said type, the encapsulation itself can be dimensioned to be thinner, and therefore a considerable amount of weight can be saved. The relief device may for example have a pressure limiting valve or a spring-loaded check valve. Alternatively, the relief device may also comprise an electromagnetic switching valve which is activated in particular by means of the described control unit.

### BRIEF DESCRIPTION OF THE DRAWINGS

Exemplary embodiments of the pressure accumulator device according to the disclosure will be explained in more detail on the basis of the drawings, in which:

FIG. 1 shows a first, simple exemplary embodiment with pneumatic activation of the relief device; and

FIG. 2 shows a second exemplary embodiment with activation of the relief device by means of a control unit.

### DETAILED DESCRIPTION

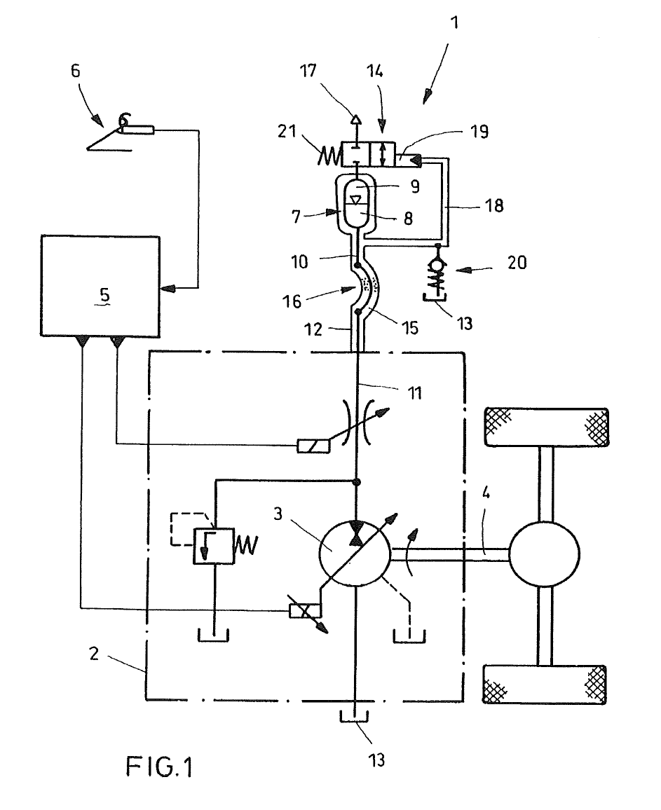

FIG. 1 shows the pressure accumulator device 1 according to the disclosure in conjunction with a hydraulic system 2 illustrated by way of example. In the illustrated exemplary embodiment, the hydraulic system 2 is provided for the recovery of kinetic energy of a traction drive. The hydraulic system 2 comprises a hydrostatic machine 3 which is connected to a drivetrain 4 of a vehicle. A control unit 5 is provided for setting the adjustable suction or delivery volume of the hydrostatic machine 3. The control unit 5 receives control signals from an accelerator pedal 6.

The pressure accumulator device 1 according to the disclosure is connected to said hydrostatic system 2. The pressure accumulator device 1 has a bladder accumulator 7 as an accumulator element. A pressure medium volume 8 and a gas volume 9 are separated from one another by a diaphragm. To store pressure energy, an accumulator line 10 is connected at one side to the bladder accumulator 7 and at the other side to a working line 11 of the hydraulic system 2. To store pressure energy, the hydrostatic machine 3 is operated as a pump and delivers pressure medium via the working line 11 and the accumulator line 10 into the bladder accumulator 7. This results in a pressure increase in the gas volume 9.

In the illustrated exemplary embodiment, an encapsulation 12 is provided which completely surrounds both the accumulator line 10 and also the bladder accumulator 7. The encapsulation 12 is in turn of pressure-tight design and extends up to the connection between the working line 11 and the accumulator line 10. Alternatively, the encapsulation could also surround only the bladder accumulator 7 or only the accumulator line 10. The encapsulation may also be divided into individual sections. This does not result in any changes to the system for detecting a pressure increase in the closed volume 15 within the encapsulation 12.

The encapsulation 12 shown surrounds the accumulator line 10 and the bladder accumulator 7 such that a closed volume 15 is formed within the encapsulation 12 but outside the bladder accumulator 7 and the accumulator line 10. Any leakage fluid escaping from the bladder accumulator 7 or the accumulator line 10 passes into said volume.

A pneumatic valve 14 is also provided, as a device for reducing the hydraulic pressure, with the gas volume 9. The gas volume 9 can be relieved of pressure into the surroundings by means of the pneumatic valve 14. For this purpose, an outlet 17 is provided on the device for reducing the hydraulic pressure, which outlet, in an activated position of the pneumatic valve 14, is connected, so as to allow a passage of flow, to the gas volume 9. In the rest position of the pneumatic valve 14, the outlet 17 is separated from the gas volume. The rest position is defined by means of a pressure spring 21 which acts on the pneumatic valve 14.

An actuator is provided for actuating the pneumatic valve 14. In the illustrated exemplary embodiment of FIG. 1, the actuator is designed in the form of a measuring surface 19. The measuring surface 19 is acted on directly by the pressure within the closed volume 15 and thus simultaneously forms a pressure sensing device. For this purpose, a connecting line 18 is provided which branches off from the encapsulation 12 and connects the volume enclosed by the encapsulation 12 to the measuring surface 19.

A relief device is provided for preventing a pressure increase, which goes beyond the magnitude required for the actuation of the pneumatic valve 14, within the encapsulation 19 in the case of large leakage quantities. In the illustrated exemplary embodiment, the relief device is realized by a spring-loaded check valve 20. The spring-loaded check valve 20 opens in the direction of a tank volume 13 if the pressure in the closed volume of the encapsulation 12 and therefore in the connecting line 18 exceeds the value predefined by the spring. The relief of the closed volume takes place into the tank volume 13 in order to ensure that, during the opening of the check valve 20, any escaping pressure medium passing through the leak into the closed volume 15 of the encapsulation 12 is reliably intercepted.

FIG. 1 shows the pressure accumulator device 1 according to the disclosure in conjunction with the preferred use of a bladder accumulator 7. It should however be noted that the device for reducing the hydraulic pressure may be designed for example to relieve the hydraulic pressure of an accumulator element in which the liquid volume is delimited by a spring-loaded piston. If the spring mount facing away from the piston side is moved by the device, the spring can be relaxed. In this case, too, the liquid volume is relieved of pressure and a further escape of pressure medium is prevented.

A swelling agent 16 is arranged in the closed volume 15 in order to intensify the pressure increase in the event of an ingress of leakage fluid.

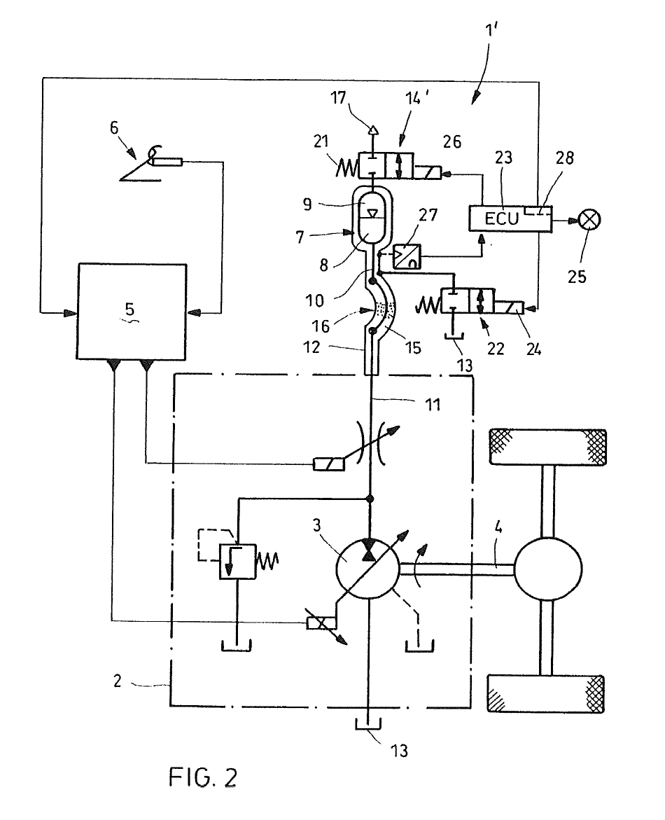

A second exemplary embodiment of the pressure accumulator device 1′ according to the disclosure is illustrated in FIG. 2. The elements already described will be explicitly mentioned again only where necessary for the understanding of the mode of operation of the second exemplary embodiment. Identical elements are provided with identical reference signs.

In the second exemplary embodiment, in contrast to the exemplary embodiment according to FIG. 1, the device 14′ for reducing the pressure in the liquid volume 8 is actuated not pneumatically but rather electromagnetically. The valve device is again designed as a 2/2 directional control valve 14′ which, in its rest position, separates the outlet 17 from the gas volume 9. An electromagnet 26 is provided as an actuator for activating the valve 14′. Said electromagnet is connected to a control unit 23. The control unit 23 is in turn connected to a pressure sensor 27 as a pressure sensing device. The pressure sensor 27 is connected to the closed volume 15 in the encapsulation 12 and generates a voltage signal if the pressure in the closed volume 15 of the encapsulation 12 exceeds a value indicative of a leak. If the threshold value is exceeded, then a control signal is generated by the control unit 23, by means of which control signal the actuator of the valve 14′ is activated. Furthermore, the control unit 23 has a connection to a warning lamp 25 in order to indicate to an operator of the vehicle that a leak has occurred.

The control unit 23 is also connected to the control unit 5 of the hydraulic system 2 and has a control section 28 by means of which a shut-down signal can be transmitted to the control unit 5. The outputting of such a shut-down signal is preferably coupled to the outputting of an actuating signal for the electromagnet 26. Therefore, when it is decided that an inadmissible pressure increase has been registered in the closed volume 15, firstly the gas volume 9 is relieved of pressure and secondly, at the same time, the hydraulic system 2 is shut down by means of the shut-down signal.

The pressure sensor 27 provides preferably a signal proportional to the pressure in the closed volume 15. In this way, not only is it possible to detect the pressure increase as a result of leakage, but erroneous triggering is also avoided. This is because the voltage signal received, which is proportional to the pressure in the closed volume 15, can be corrected in the control unit 23 with regard to a temperature influence. Such temperature influences lead inevitably to pressure changes in the closed-off volume 15 of the encapsulation 12.

Furthermore, on the basis of the signal from the pressure sensor 27, in the event of an inadmissible pressure increase within the encapsulation 12 which could cause damage to the encapsulation 12, a relief device 22 is actuated. The relief device 22 is again a 2/2 directional control valve which is held in its rest position by a spring. In the rest position, the closed volume 15 is separated from a tank volume 12. Said relief device can be placed into its switched position likewise by means of an electromagnet which, for this purpose, receives a control signal from the control unit 23. In the switched position, the volume 15 is connected to a tank volume 12. Therefore, as in the exemplary embodiment of FIG. 1, an escape of pressure medium into the environment is prevented.

It is clearly evident that the individual elements of the exemplary embodiments of FIG. 1 and FIG. 2 may be combined with one another. In particular, it is possible for example for the relief device 20 of FIG. 1 to also be used, for simplification, in a system having a control unit 23. Furthermore, it is also possible for the actuator 26 to be activated not by means of the control unit 23 but rather directly by means of a pressure switch. The pressure switch then replaces the pressure sensor 27 and is arranged in the encapsulation 12.

In both the exemplary embodiments shown, the closed volume 15 is filled with a gas, preferably with air. As a result of ingressing pressure liquid, the gas pressure is increased. In particular in the exemplary embodiment according to FIG. 2, it is also possible for a pressure change caused by a temperature change to be taken into consideration. Alternatively, the closed volume 15 may also be filled with a liquid. Liquids are incompressible, such that even a small leakage quantity leads to a considerable pressure increase even if no swelling agent is provided.

What is claimed is:

1. A pressure accumulator device for connecting to a hydraulic system, comprising:
at least one accumulator element configured to store pressure energy and having an accumulator line configured to connect the accumulator element to the hydraulic system;
a sealed encapsulation of the accumulator element and/or of the accumulator line to form a closed volume;
a pressure sensing device configured to sense the pressure in the closed-off volume; and
a device which interacts with the accumulator element, said device being configured to reduce the hydraulic pressure in the accumulator element.

2. The pressure accumulator device according to claim 1, wherein the accumulator element includes a hydropneumatic bladder accumulator whose gas pressure can be reduced by way of the device configured to reduce the hydraulic pressure.

3. The pressure accumulator device according to claim 1, wherein the device configured to reduce the hydraulic pressure comprises a valve device with an actuator, the actuator being configured to be activated in reaction to a pressure increase in the encapsulation.

4. The pressure accumulator device according to claim 3, wherein the actuator has a measuring surface which is acted on by a force dependent on the pressure in the closed volume within the encapsulation as a pressure sensing device.

5. The pressure accumulator device according to claim 3, wherein in order to activate the actuator, a control unit is provided which is connected to a sensor arrangement which, as a pressure sensing means, determines the pressure in the closed volume of the encapsulation.

6. The pressure accumulator device according to claim 5, wherein the control unit has a control section designed such that, upon activation of the actuator, a further control signal is output which is suitable for shutting down the connected hydraulic system.

7. The pressure accumulator device according to claim 3, wherein to activate the actuator, a pressure switch is provided as a pressure sensing means.

8. The pressure accumulator device according to claim 1, further comprising a swelling agent located in the closed volume, said swelling agent reacting to the increase in pressure in the closed volume upon contact with the pressure medium stored in the accumulator element.

9. The pressure accumulator device according to claim 1, wherein the encapsulation is connected to a relief device by way of which the pressure within the encapsulation can be limited to a maximum value.

10. The pressure accumulator device according to claim 9, wherein the relief device comprises a pressure limiting valve or a spring-loaded check valve.

11. The pressure accumulator device according to claim 9, wherein the relief device comprises an electromagnetically actuated switching valve.
